(19) United States
(12) Patent Application Publication
(10) Pub. No.: US 2019/0346089 A1
(43) Pub. Date: Nov. 14, 2019

(54) Light Fixture

(71) Applicant: ELITE LIGHTING, Commerce, CA (US)

(72) Inventor: Hamid Rashidi Doust, Beverly Hills, CA (US)

(21) Appl. No.: 15/973,910

(22) Filed: May 8, 2018

(51) Int. Cl. F21K 9/61; F21V 8/00; F21K 9/68; F21V 7/00

(52) U.S. Cl. CPC F21K 9/61; G02B 6/0063; G02B 6/0055; F21Y 2105/00; G02B 6/0088; F21K 9/68; F21V 7/0016; G02B 6/0043

(57) ABSTRACT

Provided is a light fixture comprising: a) a housing; b) a transparent or translucent light guide having a top and a bottom, and a left and a right side, and a first and a second end, the light guide attached directly or indirectly to the housing at the first and the second ends of the light guide; c) a source of light placed on at least the left or right side of the light guide; wherein light from the source of light travels through the light guide, and then exits the light guide from both the top and the bottom of the light guide.

### BACKGROUND SECTION OF THE INVENTION

Light fixtures are typically used to illuminate rooms. A problem with light fixtures that is that they may not offer light that is sufficiently diffused, requiring installation of additional light fixtures. Alternatively, some light fixtures may provide diffused light, but may not be able to provide a more focused light that a user may need. There is a need in the art for a light fixture that addressed the above problems.

### SUMMARY SECTION OF THE INVENTION

Provided is A light fixture comprising: a) a housing; b) a transparent or translucent light guide having a top and a bottom, and a left and a right side, and a first and a second end, the light guide attached directly or indirectly to the housing at the first and the second ends of the light guide; c) a source of light placed on at least the left or right side of the light guide; wherein light from the source of light travels through the light guide, and then exits the light guide from both the top and the bottom of the light guide. The light guide can be rectangular. The light fixture can further comprising placing a ballast on the frame. Light emitted from the top of the light guide can hit the housing and reflect downward. The light guide can have micro optics on the bottom. The micro optics can be circular. The housing can have a cavity facing downward, the light guide positioned below the cavity relative to a ceiling in such configuration that light emitted from the top of the light guide hits bottom of the housing. The cavity can be deepest in a middle of the housing, from one middle-side to another middle-side, wherein the light guide is positioned along the deepest portion of the cavity. The light fixture can further comprise a support on a length of the light guide, the support having therein the light sources. The light guide can be rectangular, and further comprising two supports attached to the left and the right sides of the light guide, the ends of the supports attached to the housing. The source of light can be a plurality of LED lights. The light LEDs can be placed on a board, the board resting on a side to orient the LED horizontally and towards the light guide. The light fixture can further comprise placing a first and a second support next to the left and the right side of the light guide, the supports attached at their ends to the housing, the LED boards placed in the support. The support can have a U shaped cross-section.

Provided is a light fixture comprising: a) a housing having a cavity facing downward relative to position of the housing installed on a ceiling; b) a rectangular transparent or translucent light guide positioned below the cavity; c) two supports, with each support on one long side of the rectangle, each end of the supports attached to the housing; d) at least two LED boards with a plurality of LED light sources placed on inside the support in such configuration that the LED light sources are oriented towards the light guide; wherein light from the LEDs travels through the light guide, and then exits the light guide from both the top and the bottom of the light guide, the light from the top hitting inside of the housing, and reflecting afterward. The light guide can have micro optics on a bottom surface. The micro optics can be circular. The micro optics can be present in the bottom ¼ of the light guide. The cavity can be deepest in a middle of the housing, from one middle-side to another middle-side, wherein the light guide is positioned along, the deepest portion of the cavity

### BRIEF DESCRIPTION OF THE DRAWINGS

FIG. 1 illustrates a cross-section of a light guide (lens) with LED lights positioned on each side of the light guide.

FIG. 2 illustrates a direct/indirect light fixture in form of a frame.

FIG. 3 illustrates a direct/indirect light fixture with a troffer housing.

FIG. 4 illustrates a top view of the troffer light fixture of FIG. 3.

FIG. 5 illustrates a back view of the troffer light fixture of FIG. 3.

FIG. 6 illustrates a side view of the troffer light fixture of FIG. 3.

FIG. 7 illustrates a side view of the troffer light fixture of FIG. 3.

FIG. 8 illustrates a side view of the troffer light fixture of FIG. 3.

FIG. 9 illustrates a side view of the troffer light fixture of FIG. 3.

### DETAILED DESCRIPTION OF THE INVENTION

Provided is a light fixture that emits light that is both focused (direct) and scattered (indirect). The light fixture can have a transparent or translucent light guide (lens) 4 that can emit light from both the bottom and top of the light guide 4. The bottom of the light guide 4 (relative to position of installation on a ceiling) can have a plurality of micro optics 8 for directing the light outside of the light guide 4, particularly in a downward direction.

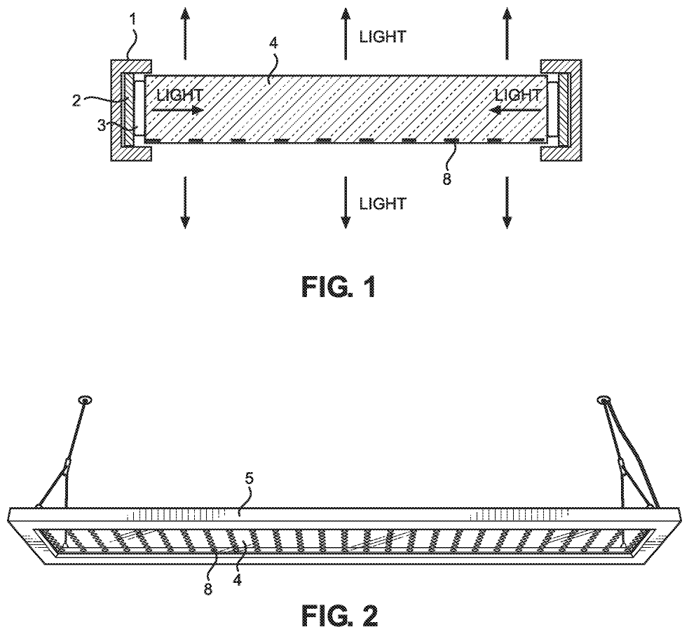

FIG. 1 illustrates a cross-section of the part of the portion of the light fixture that emits light. The light guide 4 can be made from a transparent or translucent material. The light guide can be made from plastic or glass. The light guide 4 can have the shape of a rectangle. The light guide 4 can optionally have an optical wave guide that “guides” a light wave by constraining it to travel along a certain desired path. Numerous imperfections can be introduced in the light guide to increase the chance of light reaching a certain angle. For example, a scattering member can be applied to the light guide 4. The scattering material can have a different optical density from both the light guide and air, which can result in light being transmitted from the guide 4 to the scattering material.

The light guide 4 can be transparent (with or without imperfections) and haw a portion 8 with different transparency (for example does not look as clear as the guide 4 to the naked eye) on the bottom part of the light guide 4. The portion with different optical property than the rest of the guide 4 can be individual micro optics that are on the bottom side of the light guide 4, for example, a plurality or array circular members 4 that are less transparent and/or have a different optical property than the rest of the guide 4. The circular members 8 can light the guide downward. The circular members 8 can be formed for example by etching, beads, and/or use of other methods to create a different texture with less transparency relative the clear material of the guide 4.

A support 1 can be placed on each long side of the light guide 4. The support 1 can have a U-shaped cross-section, with the cavity of the U facing horizontally towards the light guide 4. The support 1 can be made from a metal (such as aluminum) and be opaque. A light source 3 is placed inside of the cavity 7 of the support 1. Each end of the support 1 can be attached to the housing or alternatively, the support 1 can form a frame 5 without the need of an additional housing 6.

The light source 3 can be a plurality of LED lights 3. The LED lights 3 can be attached to a board 2. The board 2 with a plurality of lights 3 is placed inside the cavity 7 of the U-shaped support 1. The board 2 can be placed horizontally but also on one of its sides. The board 2 is typically a rectangle, and can rest on one of the long sides

The LED light 3 is placed against the light guide 4 in such way that the top surface of the LED light 3 touches the long side of the light guide 4. The light from the LED light 3 travels through the sides into the light guide 4. The light then can make contact with the micro optic 8 and scatter. The light is then emitted both downward and upward from the light guide.

FIG. 2 illustrates the embodiment where support 1 is placed all around the rectangular light guide, creating frame 5. LED board 2 can theoretically be placed on all sides of frame 5. LED Board 2 is can be placed only on both of the long sides, or all the rectangular sides. The light fixture of FIG. 2 can have a hook or other parts for suspending the frame 5 from the ceiling. Ballast and other electronic components can be incorporated into the frame 5.

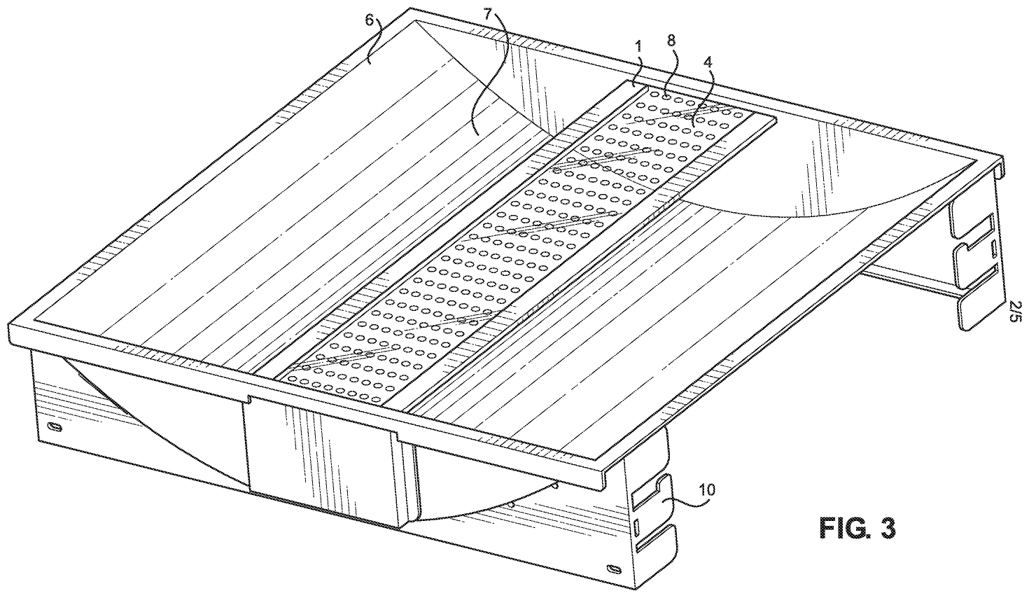

FIG. 3 illustrates a light fixture with a housing 6. The housing 6 can have an overall rectangular shape for fitting into a standard T-Bar ceiling with use of bracket 10, or alternatively be suspended. In this troffer housing, a cavity 7 exists inside the housing in a downward direction (in relation to installed position). The cavity 7 can be formed by two sides of the rectangular/square housing tapering inward. The other two sides can be flat and have no tapering. Light guide 4 can transverse the cavity along the deepest part of the cavity 7 from the top of the two sides that to not taper. The light guide 7 can have two supports 1 running along each of its long sides. The end of the supports 1 can attach the sides of the housing 6. The light guide 4 and the support 1 can have a horizontal orientation and attached to the middle of the housing 6. Visible in this view, are the microscopic optics 8 which is in the form of circles. When the light fixture is powered, light from the LED light source 3 inside of the support 1 emits light to the light guide. The light is then emitted from both below and above the light guide 4. The light emitted from the bottom provides a focused light, while the light emitted from above, hits inside of the troffer housing 6, and is scattered.

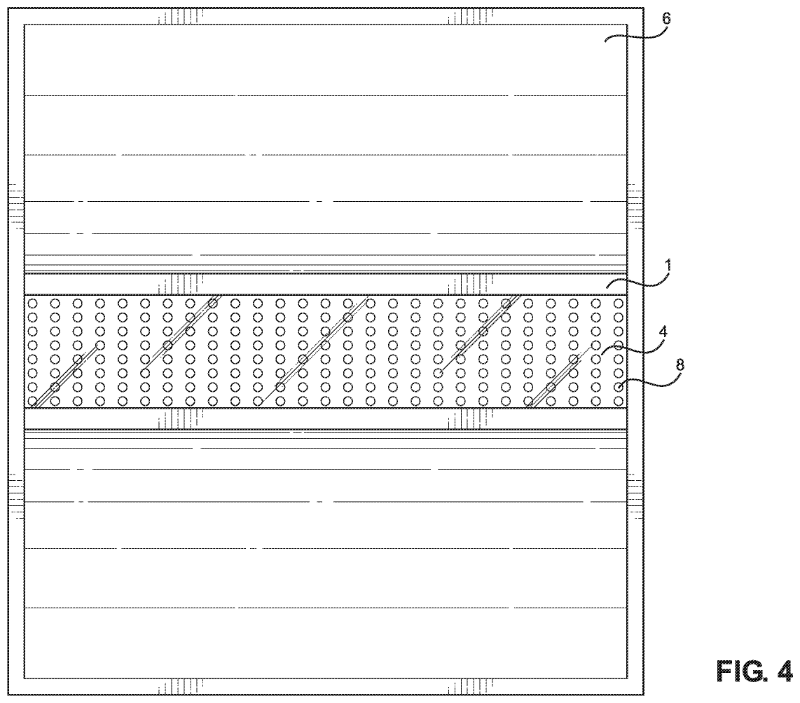

FIG. 4 illustrates a top view of the troffer housing 6. Illustrated in this view are the housing 6, light guide 4, support 1, and micro optics 8. The micro optics 8 can be on the bottom 50% or bottom 25% or bottom 15% of the light guide 4 (relative to overall height of light guide 4).

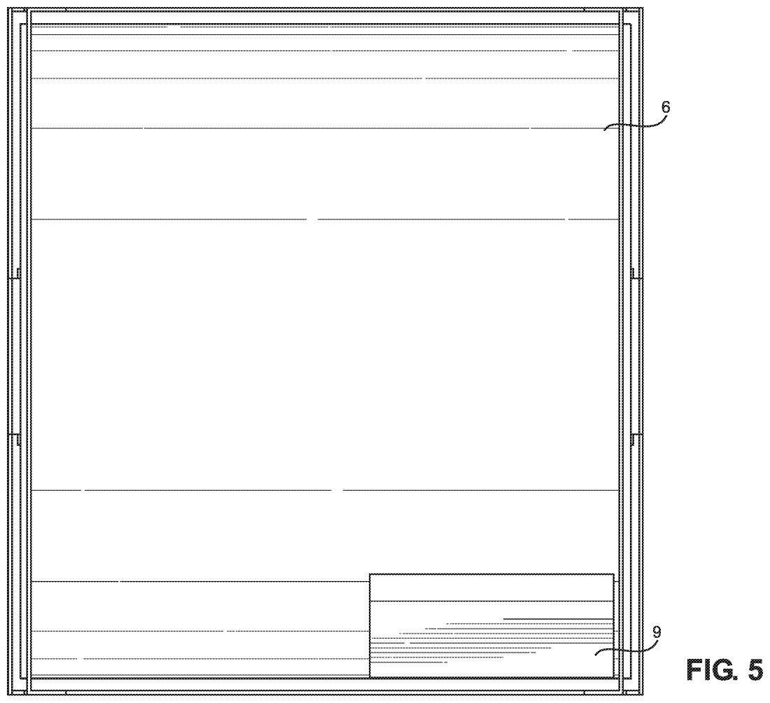

FIG. 5 illustrates the back of the troffer housing 6. A ballast 9 can be placed on the back of the troffer housing 6. The ballast 9 can receive current from an external source (outlet) and power the plurality of light sources (typically LEDs 3).

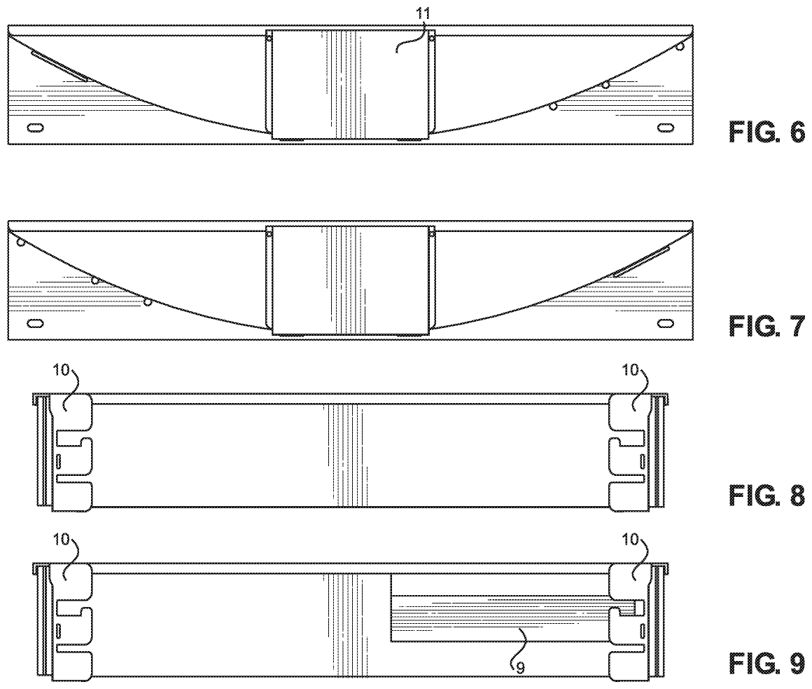

FIGS. 6, 7, 8, and 9 illustrate the sides of housing 9. FIGS. 6 and 7 illustrate placement of a cover 11 on the outside of the troffer housing 6 to cover wiring and other electronics, for example the wires connected to the LED Board in Support 1. FIGS. 6 and 7 illustrate brackets 10, which can be used to attach the light fixture to the ceiling.

### REFERENCES

1. Support
2. LED Board
3. LED
4. Light guide (lens)
5. Frame
6. Housing
7. Cavity
8. Microoptics
9. Ballast
10. Bracket
11. Cover

What is claimed is:

1. A light fixture comprising:
a) a housing;
b) a transparent or translucent light guide having a top and a bottom, and a left and a right side, and a first and a second end, the light guide attached directly or indirectly to the housing at the first and the second ends of the light guide;
c) a source of light placed on at least the left or right side of the light guide;
wherein light from the source of light travels through the light guide, and then exits the light guide from both the top and the bottom of the light guide.

2. The light fixture of claim 1 where the light guide is rectangular.

3. The light fixture of claim 1, further comprising placing a ballast on the frame.

4. The light fixture of claim 1, wherein light emitted from the top of the light guide hits the housing and reflects downward.

5. The light fixture of claim 1, wherein the light guide has micro optics on the bottom.

6. The light fixture of claim 5, wherein the micro optics are circular.

7. The light fixture of claim 1, wherein the housing has a cavity facing downward, the light guide positioned below the cavity relative to a ceiling in such configuration that light emitted from the top of the light guide hits bottom of the housing.

8. The light fixture of claim 7, wherein the cavity is deepest in a middle of the housing, from one middle-side to another middle-side, wherein the light guide is positioned along the deepest portion of the cavity.

9. The light fixture of claim 1, further comprising a support on a length of the light guide, the support having therein the light sources.

10. The light fixture of claim 1, wherein the light guide is rectangular, and further comprising two supports attached to the left and the right sides of the light guide, the ends of the supports attached to the housing.

11. The light fixture of claim 1, wherein the source of light is a plurality of LED lights.

12. The light fixture of claim 11, wherein the light LEDs are placed on a board, the board resting on a side to orient the LED horizontally and towards the light guide.

13. The light fixture of claim 12, further comprising placing a first and a second support next to the left and the right side of the light guide, the supports attached at their ends to the housing, the LED boards placed in the support.

14. The light fixture of claim 12, wherein the support has a U shaped cross-section.

15. A light fixture comprising:
a) a housing having a cavity facing downward relative to position of the housing installed on a ceiling;
b) a rectangular transparent or translucent light guide positioned below the cavity;
c) two supports, with each support on one long side of the rectangle, each end of the supports attached to the housing;
d) at least two LED boards with a plurality of LED light sources placed on inside the support in such configuration that the LED light sources are oriented towards the light guide;
wherein light from the LEDs travels through the light guide, and then exits the light guide from both the top and the bottom of the light guide, the light from the top hitting inside of the housing, and reflecting afterward.

16. The light fixture of claim 15, wherein the light guide has micro optics on a bottom surface.

17. The light fixture of claim 16, wherein the micro optics are circular.

18. The light fixture of claim 16, wherein the micro optics are present in the bottom ¼ of the light guide.

19. The light fixture of claim 15, wherein the cavity is deepest in a middle of the housing, from one middle-side to another middle-side, wherein the light guide is positioned along the deepest portion of the cavity.
